(19) United States
(12) Patent Application Publication
(10) Pub. No.: US 2007/0275811 A1
(43) Pub. Date: Nov. 29, 2007

(54) Internal Mechanical Automatic Transmission Assembly

(76) Inventor: Eran Starik, Moshav Bnei Atarot (IL)

Correspondence Address: NATH & ASSOCIATES, 112 South West Street, Alexandria, VA, 22314, US

(21) Appl. No.: 11/659,739

(22) PCT Filed: Aug. 8, 2005
(86) PCT No.: PCT/IL05/00852

§ 371 Date: Feb. 8, 2007

Related U.S. Application Data
(60) Provisional application No. 60/600,799, filed on Aug. 12, 2004.

(51) Int. Cl. B62M 11/16; B62M 11/18

(52) U.S. Cl. 475/259; 475/288; 475/289

(57) ABSTRACT

An internal mechanical automatic transmission assembly for discrete shifting of transmission ratios for forward travel, comprising a plurality of interconnectable transmission ratio producing units constituted by PTCs arranged side by side and being concatenatingly engageable and disengageable one to the adjacent in relation to a rotational speed resulting from a torque input to the transmission assembly, each of the PTCs being designed to affect a transmission ratio to thereby produce an overall transmission ratio over the transmission assembly. The transmission according to the present invention may further comprise one or more multiplication assembly

### FIELD OF THE INVENTION

This invention relates to automatic transmissions, particularly those that are mechanical and internally housed. The transmission will be described hereinbelow mainly in connection to its use with bicycles, however, it should be understood that the transmission of the present invention has many applications and can be used in conjunction with different vehicles, appliances and machines, mutatis mutandis.

### BACKGROUND OF THE INVENTION

There are numerous systems for shifting between bicycle gears to affect different ratios of transmission whereby a rider can adjust the system to a desired gear for a comfortable ride. For example, a rider may be climbing a steep hill and desire a low gear (transmission ratio) or wish to travel fast and thus desire a high gear.

There are shifting systems which require outside power (typically electric and using a battery), those that are purely mechanical, those that are externally located (exposed to the environment), those that are internal (housed), those that are manual and those that are automatic, those that are continuously variable, those that have discrete transmission ratios, those that are designed to allow for a relatively large number of transmission ratios and those that allow for few; as well as other types of variations.

Depending on the type and design, these systems may be quite complicated, add much weight to the bicycle, require carrying spare batteries and be prone to collecting dirt and receiving mechanical damage from obstacles.

A gearing assembly of the type relating to the present invention is described in U.S. Pat. No. 6,558,288 (Okochi) which discloses an internal mechanical automatic transmission for a bicycle, capable of operating a low and high gear transmission or a low, middle and high gear transmission. The device includes a slave member, a driver, a planetary gear mechanism disposed between the driver and the slave member, and an automatic shift control mechanism actuated relative to a rotational angle of the driver in a driving direction. The automatic shift control mechanism includes a first one-way clutch, a clutch control member and a first abutment member that is disposed on the inner peripheral surface of the slave member.

Additional prior art disclosing related transmission devices includes U.S. Pat. No. 3,603,178 (Lutz, et al), U.S. Pat. No. 4,098,147 (Waddington) and U.S. Pat. No. 6,010,425 (Tabe).

U.S. Pat. No. 3,603,178 discloses a dual speed hub for a bicycle equipped with planetary gearing and with first and second pawl-and-ratchet clutches respectively connecting the hub shell with the driver of the hub—which also serves as the planet carrier—and with a faster turning ring gear. The second clutch is normally disengaged by a centrifugal governor having spring-loaded flyweights pivotably mounted on the pawl carrier of the clutch and that swing in a common clockwise direction about their pivot axes under the influence of centrifugal forces sufficient to overcome the flyweight springs. An annular disc couples the flyweights so they must pivot jointly.

U.S. Pat. No. 4,098,147 describes an automatically shifting transmission drive for a bicycle wheel hub, driven by an operator's foot pedal crank. A number of planet gears journaled for rotation in the hub engage and revolve around a fixed sun gear on a mounting shaft thereby carrying and rotating the hub with them. The planet gears are connected through one-way clutches to cranks whose arms follow a cylindrical cam, the eccentricity of which is variable as a function of speed and torque. The cam is pivotally mounted from the rotating input shaft and its eccentricity is controlled by the reaction force between the cam and its followers, the centrifugal force on the cam, and a restoring force developed by a cantilever spring urging the cam to return to an initial eccentricity selectable to match the operator's capabilities. The centrifugal control force is developed by a flyweight integral with the cam and by a counterweight serving to dynamically balance the input shaft.

U.S. Pat. No. 6,010,425 discloses an automatic internal bicycle hub transmission which shifts gears in accordance with centrifugal force produced by rotation of the hub. The transmission includes a hub axle, a driver rotatably mounted to the hub axle, a slave rotatably mounted to the hub axle, a power transmitting mechanism disposed between the driver and the slave for changing a rotational speed of the driver and for communicating rotational power from the driver to the slave, a clutch mechanism for selectively engaging and disengaging the slave and the driver, and a clutch switching mechanism for controlling the operation of the clutch. The clutch switching mechanism includes an elongated weight member which pivots radially outwardly in response to centrifugal force produced by rotation of the weight member around the hub axle. A control member is operatively coupled to the clutch mechanism and is rotatable about the hub axle between an engaging position for causing the clutch to engage the driver and the slave and a disengaging position for disengaging the driver and the slave. An interlocking member is coupled to the weight member in a position spaced apart from therefrom and coupled to the control member for rotating the control member in response to radially outward movement of the weight member.

### SUMMARY OF THE INVENTION

The present invention relates to an internally housed mechanical automatic transmission assembly which allows for discrete shifting between a plurality of different transmission ratios. Shifting and production of the different transmission ratios is accomplished by concatenation of planetary transmission cassettes each of which is adapted to produce a transmission ratio to thereby produce an overall transmission ratio over the transmission assembly.

The design allows for direct downshifting to a lower non-adjacent transmission ratio.

According to other aspects, the present invention relates to a wheel hub comprising the above described internal mechanical automatic transmission, to a wheel comprising the above-mentioned wheel hub and to a bicycle or other vehicle comprising the above-mentioned wheel. The invention relates also to an appliance or machine comprising the above described internal mechanical automatic transmission assembly.

For practical reasons, the present invention is described with reference to bicycles, however without restriction thereto. Therefore the term “pedals” can be generalized to any mechanical power input/output (engine, wind turbine propeller etc.), rear wheels can be generalized to any mechanically driven apparatus (conveyer belt, electricity generator, vehicle's driving wheels etc.)

For convenience, the following definitions are provided:

PTC (Planetary Transmission Cassette)—A unit comprising a number of interacting gears by which each PTC provides a transmission ratio; also comprising a shifting mechanism that allows PTCs to interconnect in series (concatenate). A PTC comprises a planetary gear system and a ratchet mechanism which is located just farther “downstream” (farther from the sprocket, or the power input side of the hub).

Current PTC—The PTC that is locked with the hub; the overall transmission ratio is a result of the accumulative concatenating of the current PTC with previous PTCs (plus an initial transmission ratio due to the ratio between the front and rear (drive) sprocket).

Subsequent PTC—The PTC that is adjacent to the current PTC; one farther from the Sprocket.

Previous PTC—the PTC one closer to the sprocket.

Engaged PTC—the situation in which a given PTC is connected and transmitting power to its subsequent PTC.

Disengaged PTC—the situation in which a given PTC is not connected to its subsequent PTC, and thus does not transmit power thereto.

Engagement speed—the rotational speed of the component causing concatenation, whereby a PTC becomes engaged with its subsequent PTC; in particular the rotational speed of a pawl carrier or crown gear (described below) when its associated pawls (described below) swing out due to the centrifugal force produced.

Overall Transmission Ratio—is the ratio between the rotation speed of the bicycle pedals and the drive wheel (typically the rear wheel) rotation speed.

Initial (Minimal) Transmission Ratio—is the ratio between the bicycle pedals (front) sprocket to its rear sprocket.

Maximal Transmission Ratio—is the ratio between the rotational speed of the bicycle pedals and the rotational speed of the drive wheel when the transmission is in its highest gear (i.e. when the PTC farthest from the sprocket is engaged).

Non-adjacent Transmission Ratio—is the overall transmission ratio resulting from an upshift or downshift from a PTC that is not adjacent to the current PTC.

Advantages of the internal mechanical automatic transmission of the present invention (related below generally in conjunction with a bicycle, however without restriction thereto) include, among others:
Compactness—allows fitting numerous PTCs in the transmission assembly and thus shifting between a plurality of transmission ratios.
Small shifting increments—allows the rider to pedal in a comfortably narrow pedaling RPM throughout a wide overall transmission range (as a result of the compact design). Analogously, when considering a system other than a bicycle, the small shifting increments enable the power source to work at a substantially optimal power output.
It can downshift or upshift directly to a non-adjacent transmission ratio without the need to shift via each an intermediate transmission ratio until reaching the desired overall transmission ratio.
Rapid shifting—minimizes loss of power during gear transition due to the minimal motion and energy and short time period required for making the transition.
Mechanical—there is no need for auxiliary power such as a battery, etc.
Automatic—simple to use: rider need not worry or decide about which gear to use.
Efficient—small shifting increments (transmission ratios) allow the power source to operate in its optimal power producing RPM, and avoid very low or very high RPM which are not optimal in power consumption.
Safer—rider is free to concentrate on traffic issues, terrain, etc., and, multi-step downshifting allows direct shift to a lower gear preventing loss of momentum and potential stalling and falling off bike in situations such as with sharp curves (e.g. “switchbacks”) or when a steep climb immediately follows a downhill slope.
Ergonomic—the rider is not put in a situation where he must pedal harder than appropriate, as may occur, for example, when being caught in a high gear when riding uphill or upon making a sharp turn; or where he must pedal faster than appropriate, for example, when accelerating and not having up-shifted rapidly enough. This may reduce stress to the knees and other parts of the body as well as reduce the possibility of a rider falling.
Convenient—the bicycle chain is not moved from one sprocket gear to another during shifting, thus chance of the chain falling off or between or to the outside of a sprocket gear is greatly reduced.
Low maintenance—since it is internal, the negative effects of dirt and mechanical damage are mitigated. Collaterally, since the bicycle chain is not moved between sprockets for shifting, there is also less stress and wear on it, requiring fewer replacements of it and the sprocket.
Conducive to manufacture—assembled to a large extent from repeat parts, and therefore efficient to manufacture.
The system may be retrofit and be compatible to existing bicycle designs.

The present invention thus provides an internal mechanical automatic transmission assembly for discrete shifting of transmission ratios for forward travel, comprising a plurality of interconnectable transmission ratio producing units constituted by PTCs arranged side by side and being concatenatingly engageable and disengageable one to the adjacent in relation to a rotational speed resulting from a torque input to said transmission assembly, each of said PTCs being designed to affect a transmission ratio to thereby produce an overall transmission ratio over said transmission assembly. Further there is provided a wheel hub that houses the PTCs which are rotatably lockable to said hub.

A transmission according to the invention may comprise any suitable number of PTCs, at least three being a reasonable arrangement and when considering the space given in a hub of a bicycle, one may practically consider up to about 10 PTCs.

The arrangement is such that the PTCs comprise a planetary gear sub-system and a ratchet mechanism, the planetary gear sub-system comprising a central sun cog, at least two pinion gears arranged around the sun cog and whose teeth mesh with those of the sun cog, and a crown gear surrounding the pinion gears and whose teeth mesh with those of the pinion gears, the sun cog orthogonally passing through the rotational axis of a planetary gear carrier to which the pinions are pivotally held; the ratchet mechanism comprising at least one pawl engageable with a groove on the planetary gear carrier.

According to a modification of the invention the transmission of the invention further comprises a multiplying assembly which comprises a moment sleeve coaxially received within the hub and designed for engaging with the PTCs and transferring rotary motion to the hub by a unidirectional roller bearing mechanism (roller lock mechanism); a multiplier plate is rotatably fixed to the hub and is formed with one or more radial engagement members for engaging with a multiplication planetary gear assembly, which in turn is engaged with a crown gear of said moment sleeve; whereby rotation of the moment sleeve at a speed exceeding engagement speed of the multiplying engagement members entails engagement of the multiplication planetary gear assembly to thereby reduce speed of the moment sleeve and correspondingly of the PTCs.

### BRIEF DESCRIPTION OF THE DRAWINGS

In order to understand the invention and to see how it may be carried out in practice, the invention will now be described, by way of non-limiting examples only, with reference to the accompanying drawings, in which:

FIG. 1 is a side view of the rear portion of a bicycle including a wheel fitted with a transmission according to the present invention;

FIG. 2A is a perspective view of a hub according to the present invention;

FIG. 2B is a top view of the hub seen in FIG. 2A;

FIG. 2C is a side view of the hub seen in FIG. 2A;

FIG. 3 is a perspective view of a transmission according to the present invention, illustrating repeating planetary transmission cassettes thereof;

FIG. 4 is an exploded perspective view of the transmission of FIG. 3;

FIG. 5 is a front view of a gearing system of a repeating planetary transmission cassette of FIG. 3;

FIG. 6A is a perspective view of one side of a pinion carrier of the transmission of the present invention;

FIG. 6B is a perspective view of the other side of the pinion carrier of FIG. 6A;

FIG. 7 is a perspective view of a crown gear and pawl assembly of the transmission of the present invention;

FIG. 8 is a perspective view of the transmission of the present invention including a partial cut-away of the hub exposing certain internal components of the transmission;

FIGS. 9A and 9B are partial side views of a planetary transmission cassette showing the pawls in an engaged and non-engaged position, respectively;

FIG. 10A is an exploded perspective view of a first pawl carrier of the transmission;

FIG. 10B is a rear view of FIG. 10A;

FIG. 11 is a side view of a unidirectional clutch of an embodiment of the transmission of the present invention;

FIG. 12 is a side view of a pinion gear of another embodiment of the transmission of the present invention; and

FIG. 13A is a section through a transmission in accordance with a modification of the present invention, further comprising a multiplying assembly;

FIG. 13B is an isometric exploded view of the transmission illustrated in FIG. 13A;

FIG. 14 is a section along line XIV-XIV in FIG. 13A;

FIG. 15 is a section along line XV-XV in FIG. 13A; and

FIG. 16 is a section along line XVI-XVI in FIG. 13A.

### DETAILED DESCRIPTION OF THE INVENTION

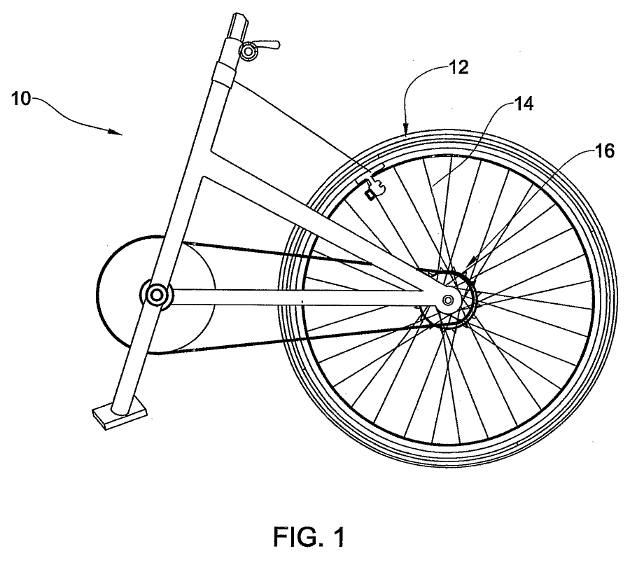

Referring first to FIG. 1 there is shown a vehicle, namely the rear portion of a bicycle 10. However the vehicle could be of another type including, for example, a moped, motorcycle, automobile, truck, tank, etc., although described herein in a manner particularly suited to non-motorized vehicles and most particularly a bicycle. Furthermore, the transmission according to the present invention is not restricted for use with vehicles and it can be utilized in conjunction with other mechanisms. Such mechanisms could be, among others, elevators, turbines, electric vehicles, jacks, pulleys, winches etc.

Only the parts of the bicycle 10 relevant to the present invention will be described, all other components thereof may be completely standard. As such, the bicycle 10 comprises a rear wheel 12 having spokes 14 and a sprocket 16 associated therewith.

For clarity, and unless otherwise stated, rotation of rotatable components will be in relation to a bicycle traveling forwards, i.e. from right to left as shown in FIG. 1. Thus, when the bicycle 10 is moving forward, the sprocket 16 will rotate counter-clockwise (CCW) in the views illustrated in the accompanying figures (i.e. with the sprocket aft of the transmission components to allow better viewing thereof).

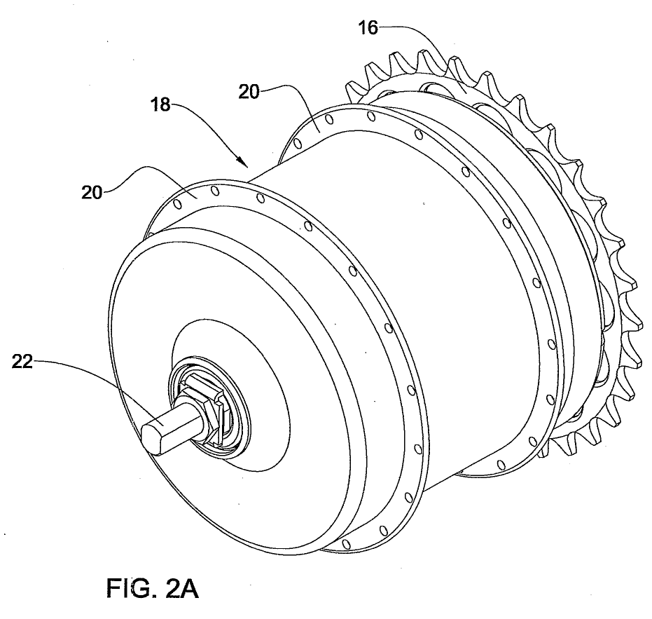

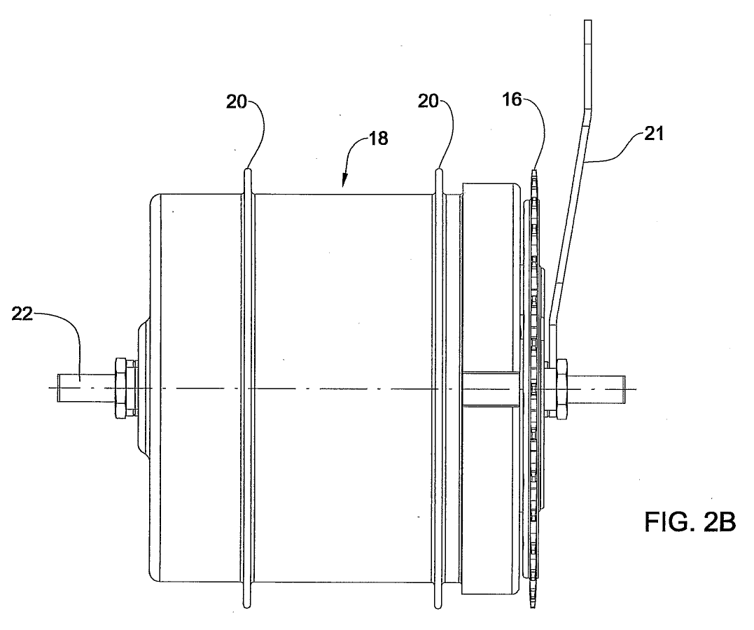

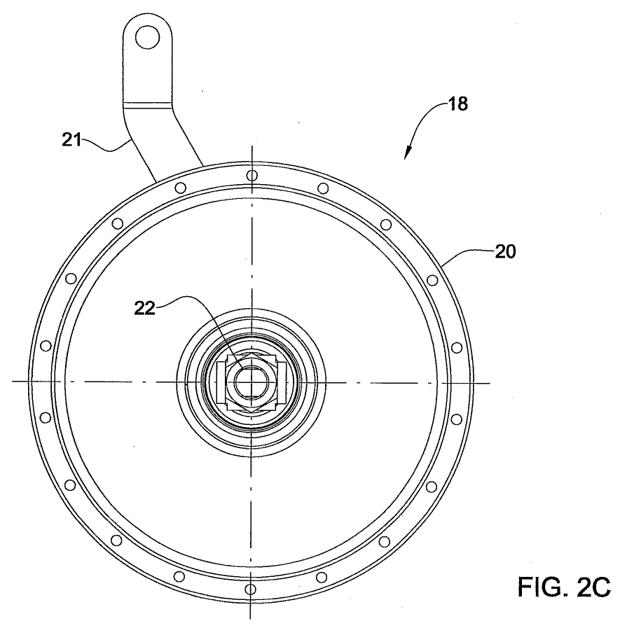

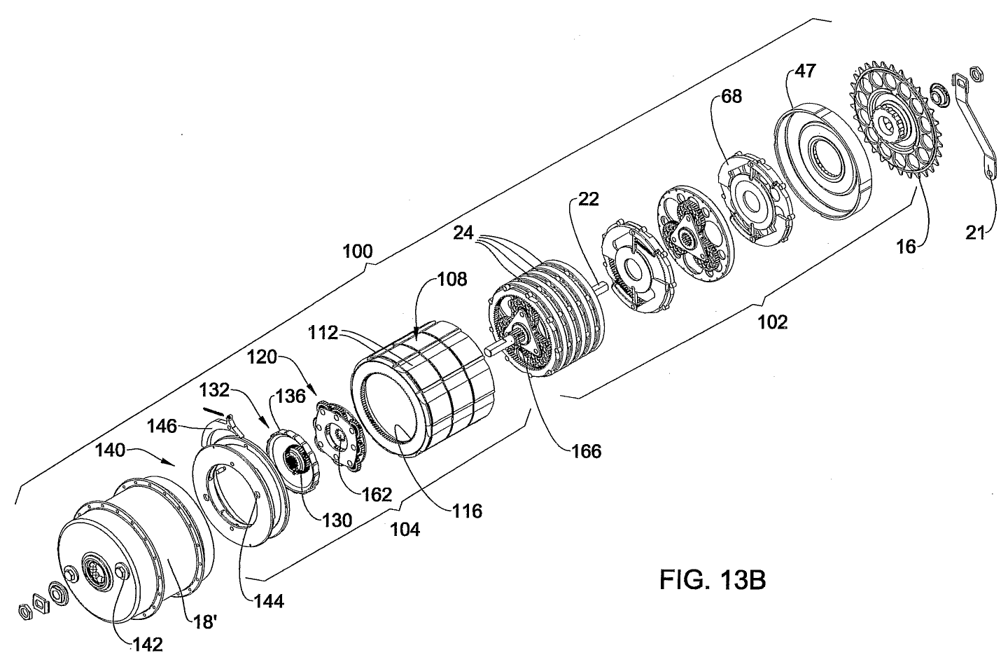

With further reference also to FIG. 2, the bicycle 10 further comprises a hub 18, which is part of, and houses, an automatic transmission (described below), the hub 18 having a pair of hub flanges 20 which transmit rotation to the rear wheel 12 via the spokes 14, and an axle 22 extending coaxially therethrough firmly connecting the whole apparatus to the bicycle frame 10. An arm 21 is provided (FIGS. 2A, 2B, 13A) for rotationally fixing the hub to a frame member of the bicycle, as known.

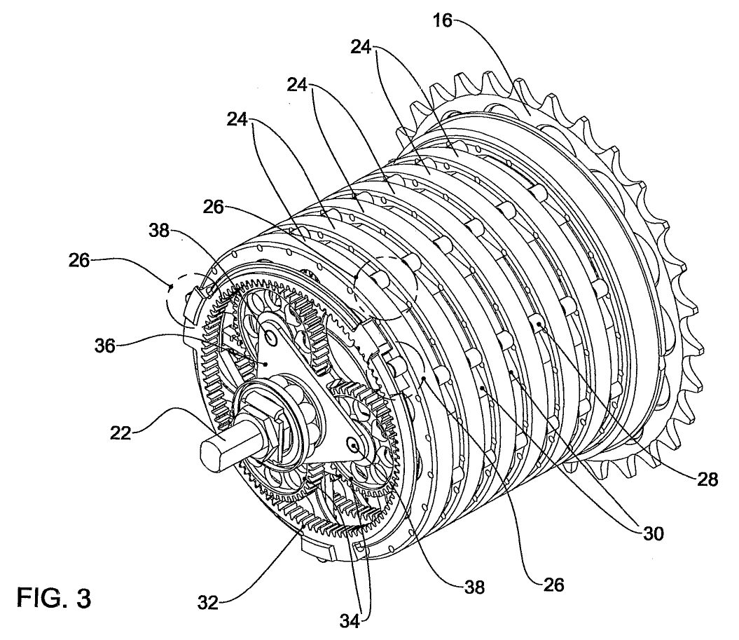

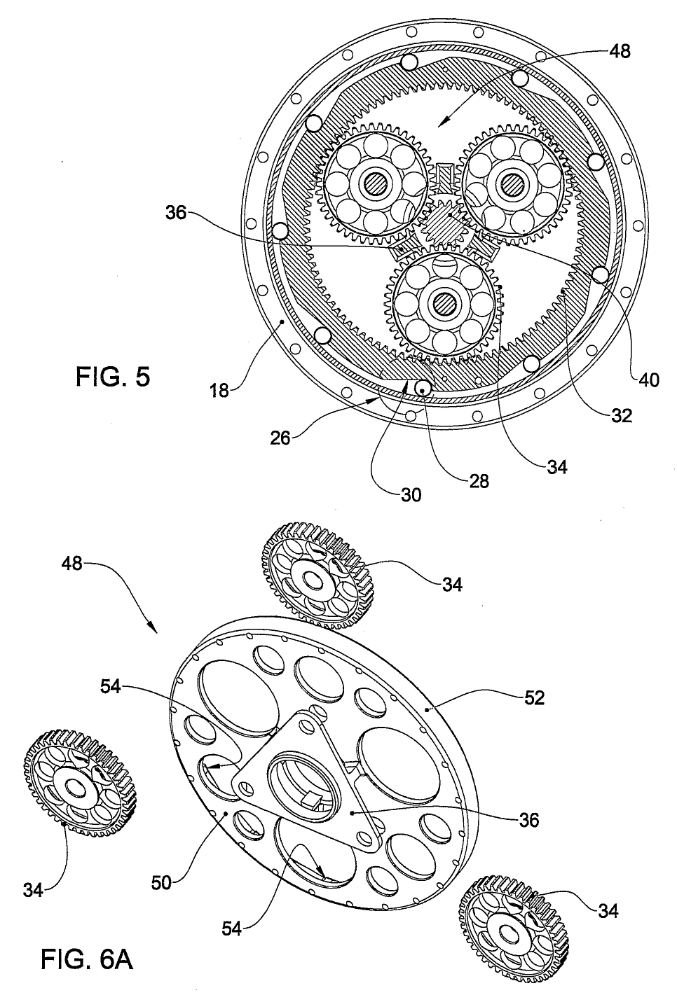

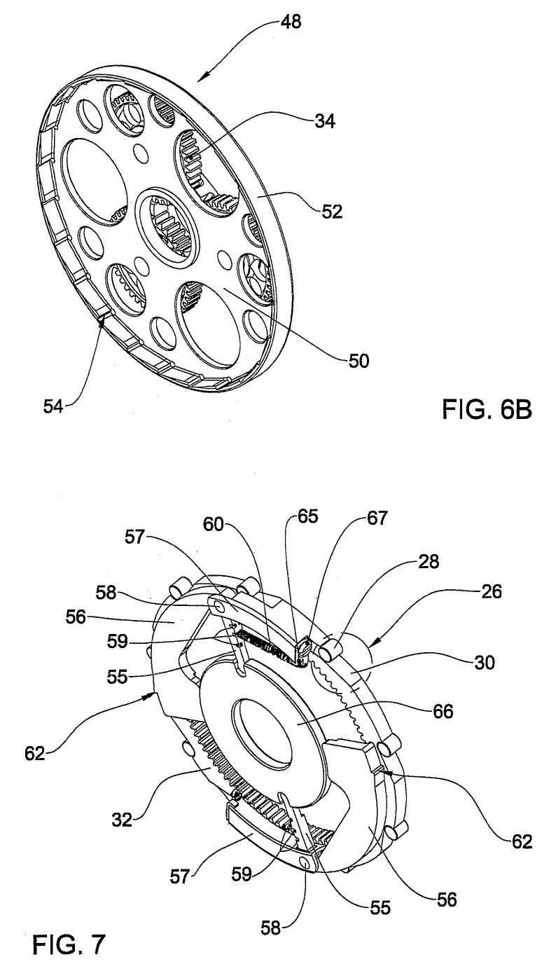

FIG. 3 shows a view as in FIG. 2 with the hub 18 removed to expose components internal to the hub 18, composed mainly of a plurality of planetary transmission cassettes (PTCs) 24 arranged side by side and serially connected (as explained below). The PTCs 24 are connectable/lockable (and disconnected/unlocked) to an inner surface of the hub 18 by unidirectional clutches 26 (unidirectional roller bearing mechanism, also referred to as roller lock mechanism), which are exemplarily shown here as consisting of a bearing pin 28 in an asymmetrical slot 30 (better seen in FIG. 5). Also visible are some of the repeat components composing the PTCs 24, for example a crown gear 32 (to which the unidirectional clutches 26 are connected—or integral with) and pinions 34 which mesh with the crown gear 32. There are typically two to five pinions 34 in each PTC 24, three shown in this embodiment. A pinion plate 36 holds the pinions 34 in place and has pinion pins 38 about which the pinions 34 may pivot (see also FIGS. 5 and 6).

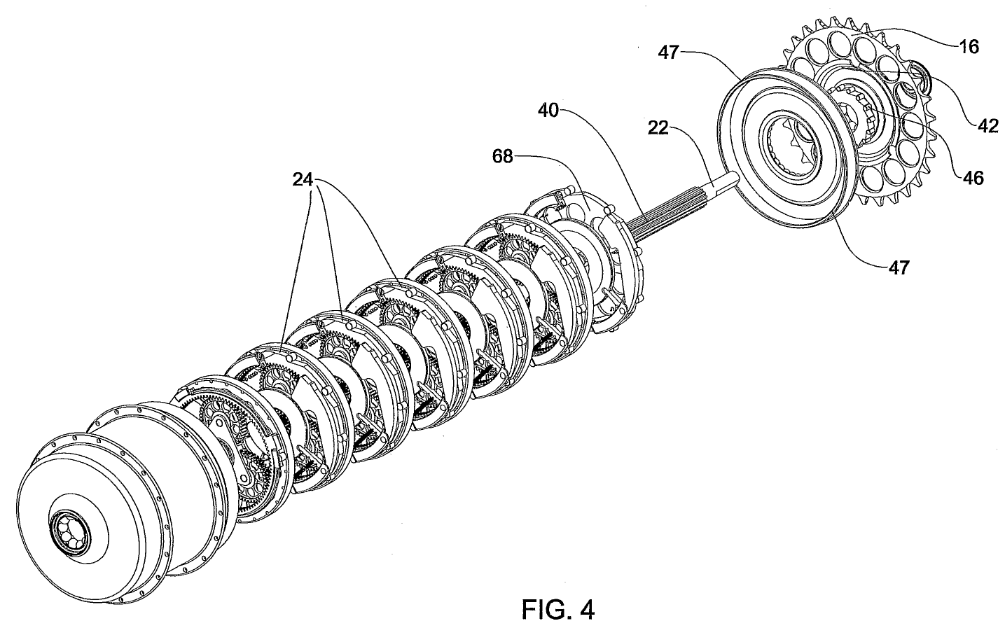

FIG. 4 is an exploded view of most of the components seen in FIG. 3 allowing a view of additional components internal to the hub 18, particularly a sun cog 40 which is typically integrally formed with the axle 22. The sun cog 40, like the axle 22, is thus fixed to the bicycle 10 and does not rotate. The PTCs 24 are only in contact with the axle 22 (or sun cog 40) via the pinions 34 (and only via the pinions 34), whose teeth mesh with those of the sun cog 40 (as best seen in FIG. 5). It can also be seen that the sprocket 16 has a drive connector 42 engaged with corresponding engagement members 46 (in the current embodiment these are pins implementing a unidirectional bearing) for transmitting power to PTC 24. A cover plate 47 packs all the components into the casing of hub 18.

Each PTC 24 is composed of two sub-systems (see FIGS. 5 to 7), one of which is a planetary gear system 48 (defined by its components) comprising the sun cog 40, the pinions 34 and the crown gear 32. The teeth of the sun cog 40 mesh with those of the pinions 34 and the teeth of the pinions 34 mesh with those of the crown gear 32; best seen in FIG. 5.

FIG. 6A is an exploded view of part of the planetary gear system 48 showing that the pinions 34 are assembled on a pinion carrier 50, held by the pinion plate 36.

The second of the two sub-systems is a ratchet mechanism located on the other (back) side of pinion carrier 50. In FIG. 6A part of the back side of the pinion carrier 50 is seen; better seen in a reverse view thereof in FIG. 6B (as this is a reverse view, the pinion carrier 50, in this particular view, will rotate CW when the bicycle 10 is traveling forward). This ratchet mechanism comprises a ratchet wheel formed by a peripheral flanged portion 52 of the pinion carrier 50 having ratchet grooves 54 formed in the inner surface thereof. Engageable with these grooves 54 are one or more pawls 56, (typically, two or more pawls symmetrically distributed provide better results). The pawls 56 may comprise weights (not shown) for affecting their reaction to centrifugal force, as known in the art.

In FIG. 7 the crown gear 32 is shown with a pair of pawls 56 arranged 180° apart (in respect to full circumference of crown gear 32) and being attached to the crown gear 32 by attachment members 57 to which the pawls 56 are pivotably joined by pawl pins 58. As such, the crown gear 32 can also be termed a “pawl carrier” and so the terms may be used interchangeably and will both use the reference numeral 32 (unless otherwise indicated). The pawls 56 comprise projections 62 corresponding to the shape of the pinion carrier's grooves 54. The pawls include a synchronization arm 55 which is a perpendicular extension of the pawl protruding towards the center (of the crown gear 32). On the synchronization arm 55 a number of attachment latches 59 are grooved. At the end of the attachment member 57 opposed to that of the pin 58, an attachment bracket 65 is connected with a screw 67. A spring 60 is tethered between the pawl synchronization arms 55 on one side and the attachment bracket 65 on the other. The spring 60 biases the pawls' 56 far end to be positioned as inwards as possible towards the center (of the crown gear 32)

It should be understood that many other types of springs, mutatis mutandis, may be used to bias the pawls 56 in various configurations.

Alternatively, there can be additional pawls, preferably evenly spaced (e.g. arranged 120° apart in the case of three pawls, 90° apart if four pawls, etc.) and preferably coupled to each other, as described hereinafter.

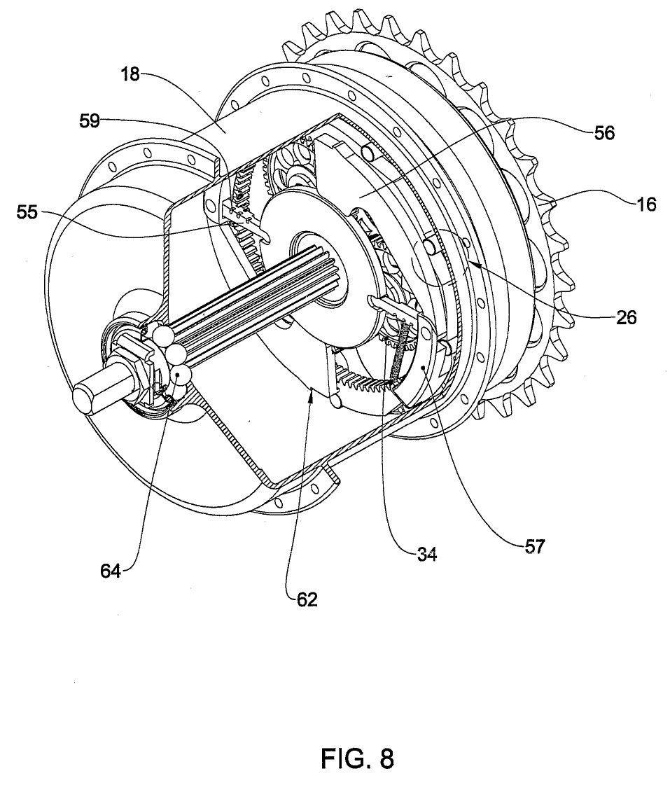

In FIG. 8 a partially cut-away view of the hub 18 provides an additional perspective of the transmission of present invention. Also visible are ball bearings 64 upon which the hub 18 spins. The unidirectional clutch 26 can be seen adjacent to the inner surface of the hub 18 with which it is lockable.

Functioning of the unidirectional clutch 26 is best understood in reference to FIG. 5 showing its asymmetrical slot 30. When the crown gear 32 rotates CCW as fast as the hub 18, the bearing pin 28 is pushed to the narrower side of the asymmetrical slot 30, which is narrower than the bearing pin's diameter, causing the bearing pin 28 to lock with the hub 18. Note, that is the current PTC 24 whose crown gear 30 locks with the hub 18.

When the crown gear 30 rotates CCW slower than the hub 18 the bearing pin 28 will reside in the wider side of the asymmetrical slot 30, which is wider than the bearing pin's diameter, so that the bearing pin 28 will not lock with the hub 18.

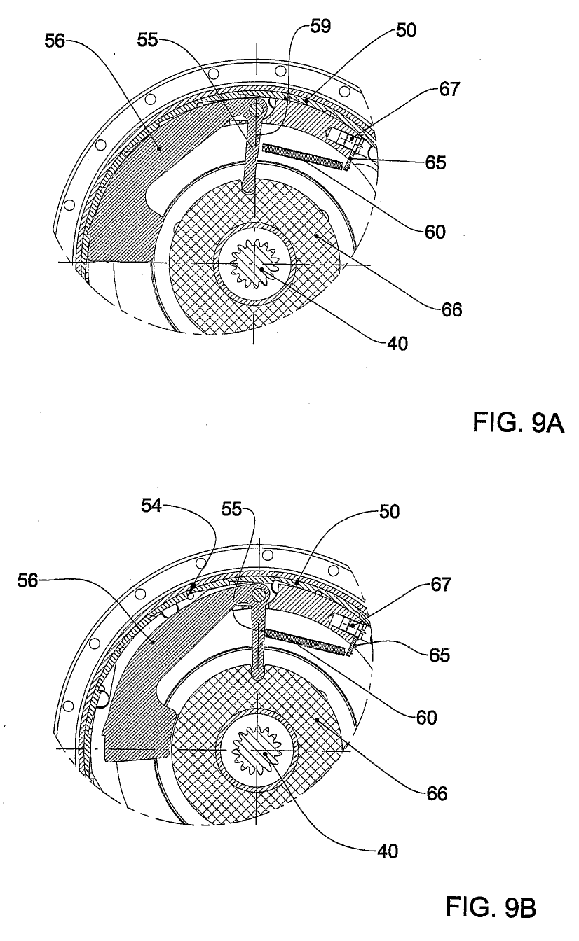

The assembly of the transmission can now be understood. During assembly, the pinion carrier 50 (FIG. 6A) of each PTC 24 is assembled on the sun cog 40 to fit over the pawls 56 (FIG. 7) of the previous PTC 24 in a manner that the PTCs 24 are concatenatingly arranged and typically are designed to fill the length of the hub 18. The PTCs 24 are connectable to each other by (and only by) the pawl-to-pinion carrier engagement (seen in FIG. 9A).

As such, a relatively large number of PTC 24 repeat units can be arranged in the present transmission, being mainly a function of the thickness of the components. Generally, thinner components can be use when the gears used are larger in diameter, requiring a larger hub diameter, as in that case the gears spin more slowly and their teeth experience less wear.

Obviously, the durability of the materials of the components is a critical design factor and typically metals, such as titanium, aluminum, stainless steel or different alloys are used. With such materials and considering a reasonable wear rate, up to ten or more PTCs may be fitted within the hub 18.

The number of transmission “speeds” is equal to the number of PTCs plus one; resulting from the maximum ratio provided by the PTCs plus the ratio provided by the ratio between the front and rear sprockets. Thus, for example, an “11-speed bicycle” could be provided with a wheel hub accommodating a 10-PTC transmission assembly.

FIGS. 9A and 9B show the pawls 56 in an engaged and non-engaged position, respectively, with their corresponding pinion carrier 50—in particular, with grooves 54 of the flanged portion 52 of the corresponding pinion carrier 50. In these figures there is also noticeable is a coupling member 66 for coupling the pawls 56 to each other such that the effect of an asymmetrical radial force on the at least two pawls 56 of each PTC 24 is cancelled. Thus, in cases where the bicycle tire hits an obstacle such as a pot-hole, curb, rock or the like, none of the pawls 56 can spontaneously become inappropriately engaged or disengaged—as the case may be.

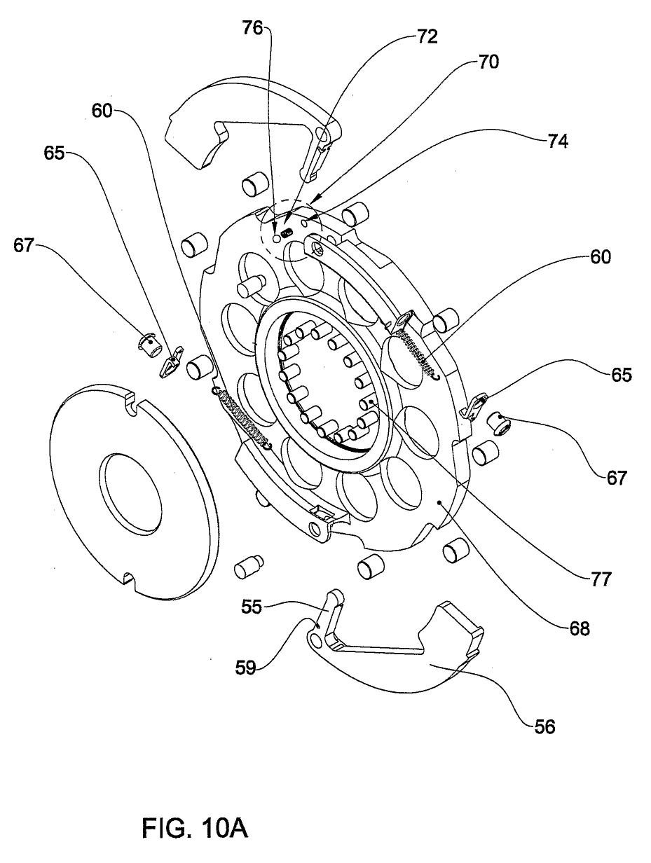

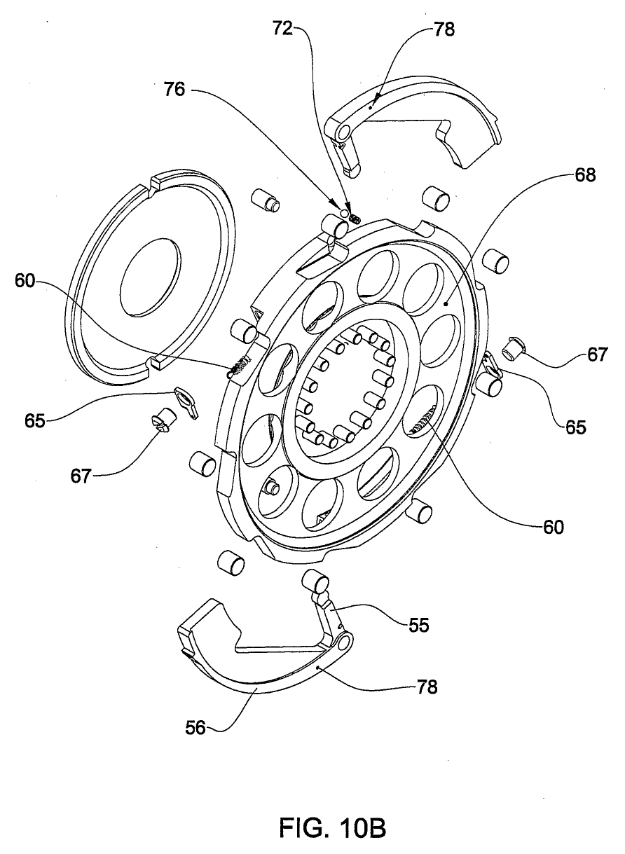

FIGS. 10A and 10B show a front and rear view, respectively, of what can be referred to as a first pawl carrier 68, which is situated adjacent the sprocket 16, as mentioned in reference to FIG. 4. The first pawl carrier 68 receives rotational power from the sprocket 16 and, above a rotational speed causing engagement of its pawls 56, this first pawl carrier 68 engages with a subsequent PTC 24.

At the other end of the series of PTCs 24 there is the crown gear 32, seen in FIG. 3. This crown gear 32 has a unidirectional clutch 26, however it does not comprise pawls 56 as it does not engage with another PTC 24 as there is no subsequent PTC 24. It can be considered that the first pawl carrier 68 (the one adjacent the sprocket 16) and this “final” crown gear 32 (the one subsequent to the PTC 24 furthest from the sprocket 16) combine to make up one PTC 24. Thus, the maximum number of transmission ratios is one greater than the number of PTCs 24.

Note, the first pawl carrier 68 is the only transmission component connected to the sprocket 16 and it does not have a pinion carrier 50 or pinions, 34 rather it receives its torque directly from the sprocket 16.

In FIGS. 10A and 10B there is further a mechanism for transferring power from the sprocket 16 to the PTCs 24 as described with reference to FIG. 4. This mechanism is represented by bearing rollers 77 in FIGS. 10A and 10B. Here, the mechanism is a unidirectional clutch type mechanism and can be a mechanism similar to those used in the unidirectional clutch 26 (or unidirectional clutch 26a described below) or the pawl/groove arrangement. As such, the mechanism allows power to be transmitted from the sprocket 16 to the first pawl carrier 68 to rotate it CCW in the view of FIG. 10A (i.e. wherein the bicycle 10 travels forward) while not impeding the pawl carrier's rotation when a rider is not pedaling forward (i.e. when the rider is coasting or pedaling backward).

Further details of FIGS. 10A and 10B will be discussed below, particularly in connection to preventing resonance and wear of the components via inducing hysteresis.

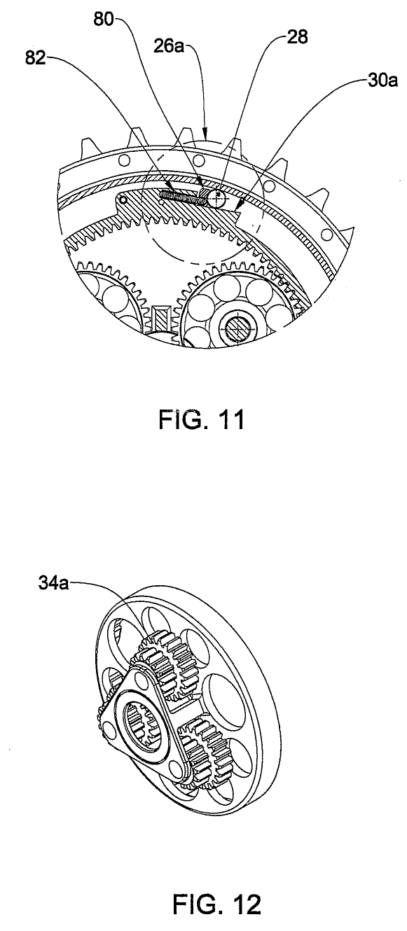

FIG. 11 illustrates a unidirectional clutch 26a which is similar to the unidirectional clutch 26, described above with reference to FIG. 5 and FIG. 8, in that it can use the same bearing pin 28 and has an asymmetrical slot 30a. However, in this embodiment, the side of the slot 30a angled closer to the crown gear 32 is open, and, its other side has a bearing interface member 80 which is biased by a spring 82 such that the interface member 80 imposes a slight force on its corresponding bearing pin 28 thereby ensuring that all the bearing pins 28 of the PTC 24 engaged with the hub 18 (the current PTC) engage essentially simultaneously with the hub 18.

Another advantage of this unidirectional clutch 26a is that the small force imparted by the spring 82 causes the crown gears 32 of subsequent PTCs 24 to already be rolling in the direction of the hub 18, thus minimizing shock on the subsequent PTC 24 when/if it becomes engaged. This feature is particularly advantageous when a rider resumes pedaling after coasting or rapidly accelerates.

However, the force of the spring 82 is not strong enough to cause the hub 18 to be locked with bearing pins 28 of crown gears 32 spinning slower than the hub 18. In fact, in PTCs 24 with pins 28 not locked with the hub 18, the pins 28 can spin freely about their own axis allowing the hub 18 to easily rotate faster than the corresponding crown gear 32 with negligible resistance; this being facilitated by the interface members 80 having an interface surface that is smooth and typically corresponds to the surface of the pins 28.

For a bicycle using the above-described transmission of the present invention, the transmission ratio of the PTCs 24 is typically in the range of 1.08 to 1.3; this being a known comfortable range for shifting between bicycle gears.

However, the transmission ratio of each PTC may practically be in the range of between 1.08 and 3, or even greater. Typically the maximal transmission ratio is at least 3.5, and the transmission ratio of each PTC is in the range 1.08 to 1.30 and the maximal transmission is at least 3.5, though it should be appreciated that these ratios may vary.

Where the number of teeth in a given PTC's sun cog 40 is Za and the number of teeth in a given PTC's crown gear 32 is Zb, the transmission ratio of the given PTC 24 is 1+Za/Zb.

It should be understood that the number of teeth (i.e. size) of the sun gear 40 could be different along its length in association with individual PTCs 24, however, the use of uniform or “repeat parts” is typically more convenient and less expensive for manufacturing and design.

In a particular embodiment of the present invention, all the gearing in the various PTCs are identical to each other, and so the ratio Za/Zb (which is typically in the range of 0.08 to 0.30) can be replaced by a single variable (e.g. X) and so the transmission ratio of each PTC is 1.X. Thus, the transmission ratio of a series of n PTCs 24 is (1.X)ⁿ and the overall maximum transmission ratio of the entire transmission system is (Initial Ratio)*(1.X)ⁿ.

One example of a practical gear teeth ratio is where the sun cog 40 has 15 teeth, the pinions 34 have 42 teeth and the crown gear 32 has 99 teeth thereby producing a ratio of 1:1+15/99 or 1:1.15 for each PTC 24.

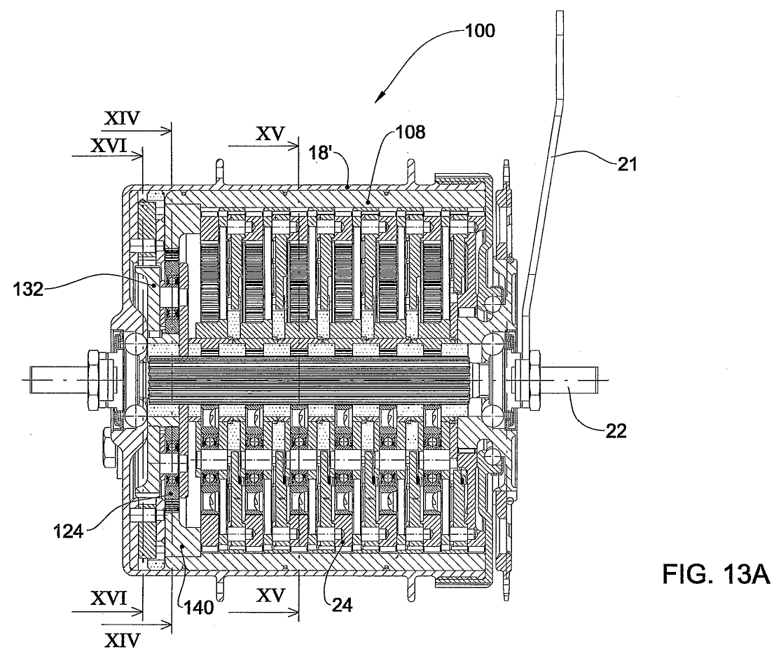

Planetary gears with ratios very close to 1.0 require large pinions in relation to the sun cog. An alternative design to allow this small ratio while reducing the overall diameter is by using dual diameter pinions 34a as illustrated in FIG. 12.

The pawl springs 60 of the PTCs 24 are set so that for each subsequent PTC 24 the springs' spring coefficient or the varying lever resulting from the varying tethering on the various attachment latches 59 of its spring on the pawl's synchronization arm 55, requires a higher centrifugal force and therefore a higher engagement speed (defined above) for the pawl 56 to swing out and become engaged. The spring coefficient ratios or attachment latches 59 position between adjacent PTCs 24 are designed to correspond to their transmission ratio i.e. if the PTC transmission ratio is 1.X then the spring coefficient of the pawl spring(s) 60 of the subsequent PTC 24 is 1.X higher than the current one or the lever of the attachment latch 59 will create a 1.X leverage compared to that to the previous one.

Reverting to FIGS. 10A and 10B, hysteresis of the pawls 56 between their engaged and disengaged positions is now discussed. Such hysteresis is desirable to avoid some negative effects, e.g. resonance, which may be associated with rapid back and forth switching between up-shifting and down-shifting upon small changes in centrifugal force on the pawls, which may produce a rougher ride, unpredictable bicycle behavior and undue wear on the gear parts. Furthermore, engagement/disengagement of the pawls 56 with their corresponding pinion carrier 50 at centrifugal forces close to the threshold point (“zero” point) which may cause floating of the pawls 56 at an in-between state resulting in slow or incomplete engagement/disengagement and which can also cause increased wear.

To preclude the above negative phenomena, for each PTC 24 the engaging transition point (the centrifugal force on the pawls 56 at which the pawls 56 swing out to engage the subsequent PTC 24) is designed to be slightly higher than the disengaging transition point (the centrifugal force at which the pawls 56 are pushed away and disengage from the subsequent PTC 24). In the case of the first pawl carrier 68 it is this carrier's rotational velocity causing the centrifugal force on the its pawls 56, whereas in PTCs 24 subsequent to the first pawl carrier 68 the pawls 56 are attached to crown gears 32 and so it is their rotational velocity affecting a centrifugal force on the pawls 56.

The above-mentioned transition points should desirably occur when opposing forces are sufficiently far away from the “zero” point so that transition happens with sufficient force and acceleration (of the pawl 56).

One example of a mechanism to achieve this is via a hysteresis inducing mechanism 70. Such a mechanism should be designed to cause a resistance R for an engaging or disengaging transition of pawls 56 above a threshold point, being when the centrifugal force minus the counter spring load on the pawls 56 is a quantity R away form the zero point.

For this purpose, according to one embodiment (FIGS. 10A and 10B), the mechanism 70 comprises a spring 72 adapted to fit in a bore 74 of an attachment member 57a (which may be otherwise the same as attachment member 57) and a ball 76. Further in this embodiment, there is a pawl 56a having an indentation, for example a shallow dimple 78, wherein the dimple 78 is aligned with the ball 76. The spring 72 biases the ball into contact with the dimple 78 of the pawl 56a thereby producing a “delta” force thereon and the desired hysteresis.

It should be understood that the required force can be produced by a variety of mechanisms and modifications thereof (e.g. via a static friction mechanism).

Operation

Transmission During Acceleration

When accelerating the bicycle 10 from a stationary position, the sprocket 16 will be driven by the bicycle's chain and will transmit the motion and torque to the hub 18 and from there, via the spokes 14, to the rear wheel 12. At this point, the entire set of PTCs 24 is idle and not revolving and the bicycle 10 is acting as if it is a single-speed transmission bicycle with a transmission ratio equal to the “initial ratio” (or “first gear”).

As bicycle's speed increases and a threshold centrifugal force is reached, the pawls 56 of the first pawl carrier 68 in the will swing out and engage the grooves 54 of the pinion carrier 50 of the subsequent PTC 24. It should be recalled from the above description that the first pawl carrier 68 is engaged by the sprocket 16 via its drive connector 42 which engages with the corresponding engagement members 46.

Engagement of the pawls 56 of the first pawl carrier 68 with the pinion carrier 50 of the subsequent PTC 24 causes that pinion carrier 50 to receive power input from the first pawl carrier 68 and rotate. Rotation of the pinion carrier 50 around the sun cog 40 causes the three pinion gears 34 to rotate (around the sun cog 40), and, since their teeth are meshed, the pinions 34 will spin around their own axes. This will transmit power to the crown gear 32 causing it to rotate, and when reaching the speed of the hub 18, the unidirectional clutch 26 will become locked with the associated PTC 24 (current PTC) to the hub 18.

When this (first) PTC 24 locks with the hub 18 an overall transmission ratio of 1.X*(Initial Ratio) is produced (i.e. “second gear”).

Gears three to n: With an increase in rotational speed, and thus centrifugal force, the above logic will repeat itself, resulting in concatenation of further PTCs 24, resulting in an incremental increase in the overall transmission ratio. Thus, in its turn, upon the appropriately higher centrifugal force, the pawls 56 of the current PTC 24 swing out and into engagement with the pinion carrier 50 of its subsequent PTC 24 whereby its crown gear 32 locks with the hub 18 via its unidirectional clutches 26.

Upon the locking of the unidirectional clutches 26 of the current PTC 24 with the hub 18, the previous PTC 24 will rotate 1.X slower than the hub 18 and the unidirectional clutches 26 of the previous PTC 24 will unlock from the hub 18 and roll 1.X times slower than the current PTC 24 (and the hub 18).

Since the spring coefficient of the pawl springs 60 or the pawls' attachment latch 59 leverage of the series of PTCs 24 are designed to increment in correspondence to the incremental increase/decrease) in overall transmission ratio produced by engagement/disengagement of the PTCs 24, the pawls 56 will engage/disengage at a centrifugal force appropriate to when a higher/lower overall transmission ratio is warranted.

In other words, for each PTC 24, its pawl springs 60 have a different spring (or attachment latch 59) such that each spring 60 provides a larger resistance than the pawl springs 60 of the previous PTC 24. The pawls 56 of each PTC 24 have springs 60 with a spring coefficient (or attachment latch 59) corresponding to the centrifugal force, or rotational speed, at which that PTC's pawls 56 are intended to swing out and engage a subsequent PTC. The increment in the spring's spring coefficient (or attachment latch 59) between a PTC and its subsequent PTC directly corresponds to the increment in transmission ratio between those PTCs. Thus, if the current PTC 24 affects a 1.X transmission ratio, then the ratio between its pawl springs 60 and the pawl springs 60 of the subsequent PTC 24 is 1.X. As a result, engagement between any given two PTCs 24 always occurs at a particular rotational speed of the sprocket 16 (i.e. pedaling speed).

Transmission During Deceleration:

When the bicycle 10 slows down from a relatively high speed, and thus relatively high gear, there will be a reduction in the centrifugal force acting on the pawls 56. When the centrifugal force falls below a threshold value for the pawls 56 of the currently engaged PTC 24, those pawls 56 will be pushed inward by their associated pawl springs 60, and the current PTC 24 will become disengaged and a corresponding reduction in the overall transmission ratio will result.

Although it may have become understood, it is worth noting that the design of the automatic transmission of the present invention will result in a pedaling cadence falling within a fairly constant range for all bicycle speeds between the speed causing engagement of the first PTC to that of the last. However, once in the highest gear, the rider can pedal faster in order to ride faster.

Gear/Transmission States:

A PTC can be in one of 3 states:

1. Disengaged—when the hub's/wheel's rotational speed is below the previous PTC's engagement speed; i.e. when it is subsequent to the current PTC 24 (farther away from the sprocket 16) and it is not engaged with a previous PTC 24. Further, the crown gear 32 is either static or rolling freely—or, in the case where it is equipped with a unidirectional clutch with a biasing aspect such as unidirectional clutch 26a, it is rolling in the direction of the hub 18, due to the friction between the hub 18 and the bearing pin 28 of the clutch 26a biased by its spring 82 (see FIG. 11), although slower than the hub 18.

In this state the PTC 24 is disengaged from previous and subsequent PTCs.

2. Active—locked with and transmitting torque to the hub 18; and engaged with the previous PTC 24. Only the current PTC 24 is “active”. This state is achieved when the rotational speed of the previous PTC's crown gear 32 rotates at a speed producing a centrifugal force so that its pawls 56 will swing and latch on the current PTC's pinion carrier grooves 54 whereby the current PTC 24 becomes active.

When active (in state 2), rotation of the previous PTC's crown gear 32 (“pawl carrier”), via its pawls 56, transmits torque (via pawls 56 attached to that crown gear 32) to the pinions 34, via the pinion carrier 50 of the current PTC 24, onward to the current PTC's crown gear 32, and from there to its crown gear 32 and from there to the hub 18—when its unidirectional clutch 26 or 26a lock thereto,—as described above. This (current) PTC 24 is now transmitting the torque from the sprocket 16 to the hub 18 and is the active, or current, PTC 24.

3. Passive—engaged with the previous and subsequent PTC and receiving power and, transmitting torque thereto (respectively); they are PTCs 24 closer to the sprocket 16 than the current (active) PTC 24 and so are not locked to the hub 18).

This is the state of PTCs 24 that are previous to the current PTC 24. As just stated, a PTC's crown gear 32 may reach the rotational speed producing a centrifugal force so that its pawls 56 will swing and latch on the subsequent PTC's pinion carrier's grooves 54 transitioning that (subsequent) PTC 24 to state 2 (active, hence—a current PTC 24). All PTCs 24 previous to the current one are also in the passive state.

Thus, when a PTC's engagement speed is reached it connects to the next PTC 24. The next PTC 24 is now the current (active) PTC and the previous has become a passive PTC (state 3; like any PTCs previous to it). The engagement of the next/subsequent PTC 24 causes the overall transmission ratio to increase by a factor of 1.X.

At any speed, the following is true:

Only one PTC 24 is active—state 2 (referred to as PTCⁿ)

1. PTC¹ to PTCⁿ⁻¹ are:
a. Engaged one with the other (concatenated) but passive (state 3) and rolling slower than the hub 18.
b. Receiving torque from the PTC 24 prior to it (the PTC one closer to the sprocket 16) and transmitting to the subsequent PTC 24; not transmitting torque from the sprocket 16 to the hub 18.
c. In the situation where their pinion carriers 50 revolve at same speed as the pawls 56 of the previous PTC 24. Via the pinions 34, the pinion carrier 50 is driving the crown gear 32 which is driving the subsequent PTC 24 via its pawls 56 and these crown gears 32 are rotating slower than the hub 18.

2. PTCⁿ⁺¹ to PTC^{final} are:
a. Disengaged (state 1) from subsequent/previous PTCs 24.
b. Not receiving or transmitting torque.
c. The crown gear 32 is either static or rolling at the rotational speed of the hub 18 (due to friction of the unidirectional clutch, as described above).

It should be understood from the above description that the present transmission assembly may automatically perform the desirable direct downshifting to a “non-adjacent” PTC 24. For example, if a rider was riding rapidly, and so in a relatively high gear (overall transmission ratio), say 8^{th} gear, and the rider were to suddenly slow down a much slower speed (or even to a complete stop), the transmission assembly would automatically downshift directly to the appropriate (much) lower gear (say 3^{rd} gear) without the process of shifting from 8^{th} gear; to 7^{th} gear; to 6^{th} gear; etc. prior to arriving to 3^{rd} gear.

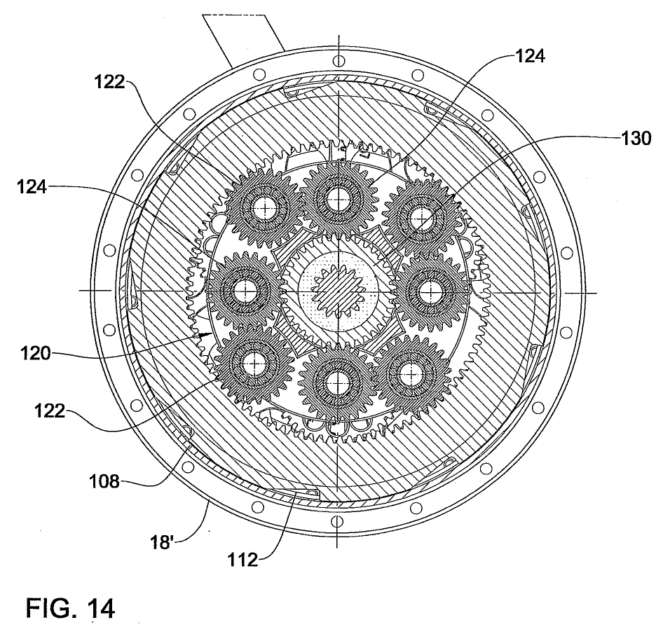

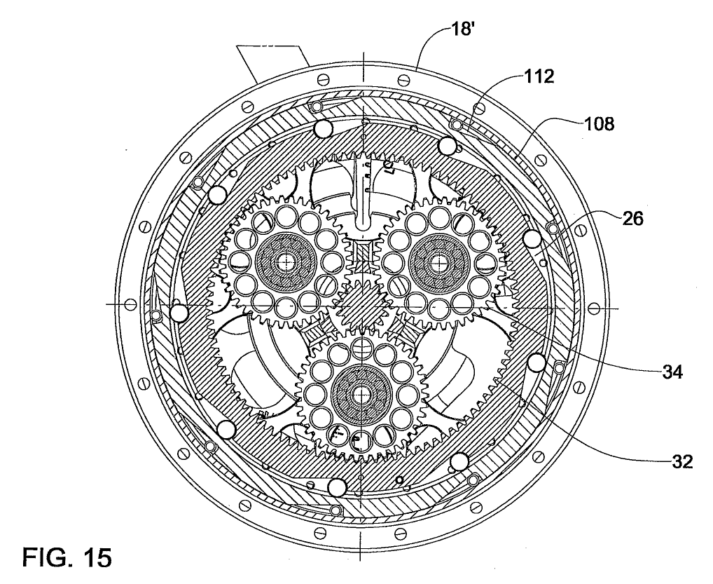

According to a modification of the invention, the transmission may comprise a doubling (“multiplication”) configuration transmission, as illustrated with reference to FIGS. 13A to 16.

According to this configuration, the hub generally designated 100 has an external appearance similar to that illustrated in connection with the previous embodiment (FIG. 2) and further, most of its internal components are similar with those described in connection with the previous embodiment and thus, like elements are designated same reference numbers. In FIG. 13B, the components collectively designated 102 are directed to the transmission similar to that described in the previous drawings, as described as hereinbefore, whilst components collectively referred to at 104 are concerned with the multiplication assembly as will become apparent hereinafter.

The multiplication assembly 104 comprises a moment pickup member in the form of sleeve 108 having an internal structure similar to that of hub 18 allowing for rotational engagement by any one of the unidirectional clutches 26, of the respective PTCs, as illustrated for example in FIG. 5. Similarly, sleeve 108 comprises on its periphery a plurality of unidirectional external clutches 112 (coaxially arranged within grooves formed on its outer face) for rotational engagement within the external hub casing 18′, which for that purpose, may be of slightly larger diameter so as to accommodate sleeve 108.

A fore-end of sleeve 108 comprises a geared crown ring 116 accommodating a pinion plate assembly 120 which is rotatably fixed to the axle 22. Crown ring 116 transfers rotary power and motion to pinion gears 122 (four in the present example) which are assembled on pinion plate 120, each being engaged in turn with a corresponding inverting gear 124. The inverting gears 124 are engaged in turn with a central sun cog 130 of a cog plate 132 The multiplication ratio is defined by the transmission ratio of the pinion plate assembly (i.e. the overall transmission ration defined by the crown, pinion and sun gears).

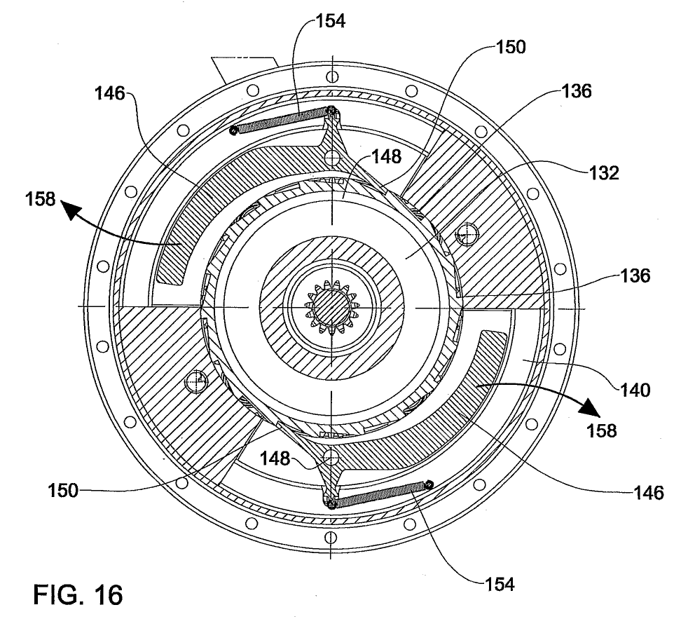

Cog plate 132 is formed on its periphery with a plurality of engagement notches 136 (see also FIG. 16). The multiplication output is transferred from the cog plate 132 to a multiplier engaging member 140, which is fixed to the hub 18′ by means of bolts 142 screwed into bores 144 of the multiplier engaging member 140. The multiplier engaging member 140 comprises a pair of spring biased pawls 146 (best seen in FIG. 16) pivotally articulated at 148 within the ring 140 and each comprising an engagement prong 150 for rotationally arresting the cog plate 132 against any one of shoulders 136 as illustrated in FIG. 16. It is noticed that the pawls 146 are normally biased into a disengaged position by means of coiled tension springs 154, whereby angular pivotal displacement of the pawls 146 in the direction of arrows 158 will occur only after reaching an engagement speed (predetermined angular velocity) giving rise to centrifugal forces for such displacement to take place, eventually resulting in engagement of prongs 150 of pawls 146 with said ribs 136, as in FIG. 16, so as to rotationally arrest the cog plate 132.

During the course of operation, each of PTCs 24 engages in turn with the sleeve 108 in the same manner as explained in connection with the previous embodiment, whereby rotational output is then transmitted to the hub 18′ via unidirectional external clutches 112. However, upon reaching the engagement speed (maximum nominal speed of the last PTC 24), the angular velocity of member multiplier engaging member 140 causes the pawls 146 to angularly tilt about axis pins 148 into engagement with the cog plate 132, whereby the pinion plate assembly 120 of the multiplier assembly causes sleeve 108 to slow down. At this situation the overall transmission rate is now multiplied by the actual mechanical multiplication ratio of the multiplier assembly, followed by consecutive decrease as of the transmission ratio of the PTCs (owing to the pinion plate assembly 120). Further rotation of the sprocket 16 (e.g. by pedaling) will entail automatic gear shifting as discussed in connection with the previous embodiment, though at a multiplied ratio.

It should be clear to the artisan that in accordance with a further modification (not shown) a second multiplication assembly may be provided, whereby the transmission ratio may be even increased.

In the multiplication gear assembly, a single output grade gear is designed to allow multiplication of the transmission states allowed by the PTCs. Assume that the gear contains N PTCs and one multiplication gear, then the number of overall transmission states will be 2*(N+1). In this configuration, the multiplication gears (116, 122, 124 and 130) transmission ratio will be generally higher than (1.X)**N and in one sensible embodiment it will be (1.X)**(N+1). The engagement speed of pawl 146 will be higher than that of PTC N and in a sensible embodiment 1.X times higher. During acceleration, the PTCs will engage one by one. When gear N is engaged and speed increases by 1.X, the multiplication pawl 146 will engage, causing a sudden transmission ratio increase of (1.X)**(N+1). Since the PTC array is driving the multiplication gear through the sleeve 108, and since the driven momentum (vehicle body) is customarily much larger than the driving momentum (engine momentum) this engagement will cause the sleeve 108 and all PTCs to slowdown by (1.X)**(N+1) and all PTCs will immediately disengage, When speed increases further by 1.X the first PTC will engage causing the overall transmission ratio to grow to 1.X**(N+2) and so on until reaching (1.X)**(2N+1).

Operation of Inverted Gear Configuration:

An alternative operation modality of the invention is to implement an inverted gear. The regular gear implements a fixed input and increasing output. The inverted gear implements an increasing input and fixed output. Such functionality is applicable to devices which are powered by greatly varying power sources while optimally requiring a fixed input RPM. An example application can be, but not limited to, an air-condition compressor in a car is powered through a belt by the engine. Since engine RPM may vary between 1000 and 6000 RPM, this creates an overly wide input speed range at the entrance of the compressor, sometimes resulting in lack of power when engine is idle and overload on the compressor when engine is at high RPM. An inverted gear will stabilize the compressor RPM to a small defined range under any engine input RPM.

The implementation of an inverted gear may be done through using gears with other planetary configurations. However for the sake of brevity and simplicity, it suffices to show, that if the current embodiment is used so that the power input arrives from the hub 18, and the power output extracted from the sprocket 16, and providing that the direction of rotation is counter the direction described thus far, then the result will be an inverted gear as described in the paragraph above. In the example used above, the same belt that today drives the compressor's input axle, may attach to the hub through belt interface which is formed on the hub's exterior, while the output arrives from the hub's side through the drive connector 42 which in this case would be connected directly to the compressor's shaft (rather than to a sprocket).

The automatic transmission of the present invention has been described in conjunction with a bicycle. However, it should be understood by one knowledgeable in the art that, mutatis mutandis, the transmission could be used in many other applications, examples of which are (grouped into fields):
Electric vehicles (e.g. electric vehicle for disabled people or wheel chair, electric bicycle or scooter, fork lift, train, golf cart, moped and the like)
Combustion engine vehicles (e.g. scooter, moped, motorcycle, automobile, all-terrain-vehicle, snow mobile, jet-ski vehicle). This includes usage of inverted gear for stabilizing input RPM of compressor, alternator etc. under widely varying engine RPM;
Humanly driven vehicles (e.g. bicycle, wheel chair, boat);
Winches, pulleys, Jacks and reels (e.g. sail boat winch, jeep winch, retractable shades, car lifting jack, fishing rod reel);
Turbines and propellers (e.g. wind turbine etc.);
Elevators and escalators;
Home accessories (e.g. laundry machine, clothes dryer, mixer, fan, food processor, grinder, sewing machine, lathe and drill, etc.);
Toys (e.g. motorized toy car, boat and plane);
Industrial and civil engineering applications (e.g. conveyer belts, cranes and lifts).

Whilst several embodiments have been shown and described, it is to be understood that it is not intended thereby to limit the disclosure, but rather it is intended to cover all embodiments, modifications and arrangements falling within the spirit and the scope of the present invention, as defined in the appended claims, mutatis mutandis.

1. An internal mechanical automatic transmission assembly for discrete shifting of transmission ratios for forward travel, comprising a plurality of interconnectable transmission ratio producing units constituted by PTCs arranged side by side and being concatenatingly engageable and disengageable one to the adjacent in relation to a rotational speed resulting from a torque input to said transmission assembly, each of said PTCs being designed to affect a transmission ratio to thereby produce an overall transmission ratio over said transmission assembly; the transmission further comprises a wheel hub that houses the PTCs which are reversibly lockable to said hub.

2. The transmission assembly according to claim 1, wherein said assembly is designed such that the cadence of the rotational input to the transmission remains within a relatively narrow range when said transmission upshifts to a higher transmission ratio.

3. The transmission assembly according to claim 1, wherein the PTCs are reversibly connectable one with a previous and/or subsequent PTC via a ratchet mechanism.

4. The transmission assembly according to claim 3, wherein the PTC's ratchet mechanism comprises at least one pawl of a previous PTC engageable with a ratchet wheel of a subsequent PTC.

5. The transmission assembly according to claim 1, wherein the PTCs comprise a planetary gear sub-system and a ratchet mechanism, the planetary gear sub-system comprising a central sun cog, at least two pinion gears arranged around the sun cog and whose teeth mesh with those of the sun cog, and a crown gear surrounding the pinion gears and whose teeth mesh with those of the pinion gears, the sun cog orthogonally passing through the rotational axis of a planetary gear carrier to which the pinions are pivotably held; the ratchet mechanism comprising at least one pawl engageable with a groove on the planetary gear carrier.

6. The transmission assembly according to claim 5, wherein the crown gear comprises at least one unidirectional clutch mechanism allowing for locking of the crown gear of the current PTC to a wheel hub, to transmit rotation thereto, and allow unlocking thereof to allow said hub to rotate relative to said crown gear.

7. The transmission assembly according to claim 6, wherein the at least one unidirectional clutch mechanism includes an arrangement for providing a small frictional force contact between said clutch and the wheel hub whereby the crown gear of unengaged PTCs will rotate in the direction of the hub but said hub can rotate faster than said crown gears of unengaged PTCs.

8. The transmission assembly according to claim 5, wherein the pawl is pivotably connected to the crown gear and adapted such that above a rotational speed of the crown gear a threshold centrifugal force is achieved causing the pawl to swing away from the crown gear and engage with said groove.

9. The transmission assembly according to claim 8, further comprising a spring associated with each pawl of each PTC adapted to bias the pawl in a direction counter to any centrifugal force imparted to each pawl.

10. The transmission assembly according to claim 9, wherein the spring associated with each pawl of each subsequent PTC is adapted to produce an incrementally greater counteracting force with each successive PTC.

11. The transmission assembly according to claim 10, wherein the spring is adapted such that its incrementally greater counter acting force corresponds to the increase in the overall transmission ratio caused by the concatenation of the PTCs.

12. The transmission assembly according to claim 10, wherein the incrementally greater counteracting force produced by the springs is a result of correspondingly incremental differences in their spring coefficients.

13. The transmission assembly according to claim 6, wherein upon a reduction in rotational speed of the hub above a threshold value, the unidirectional clutch of the current PTC locked with the hub, disengages therefrom as a result of the at least one pawl of at least the previous PTC disengaging from the pinion carrier of said current PTC.

14. The transmission assembly according to claim 6, wherein upon a relatively sudden reduction in rotational speed of the hub of a magnitude to effect a downshifting wherein the current PTC disengages from more than one previous PTC in a series, the overall transmission ratio is directly downshifted a lower non-adjacent overall transmission ratio.

15. The transmission assembly according to claim 6, wherein upon a reduction in the centrifugal force on the one or more pawls of the current PTC, above a threshold value, the one or more pawls of at least the previous PTC disengages from the pinion carrier of said current PTC.

16. The transmission assembly according to claim 6, wherein upon a reduction in the centrifugal force on the one or more pawls of the current PTC and at least two of the previous PTCs is of a magnitude to cause at least those pawls to disengage from their corresponding planetary gear carriers, the overall transmission ratio is directly downshifted to a lower non-adjacent transmission ratio.

17. The transmission assembly according to claim 1, wherein the geometry and configuration of each PTC repeat unit is identical whereby each said PTC repeat unit is adapted to affect the same transmission ratio.

18. The transmission assembly according to claim 1, wherein the transmission ratio of each PTC is between 1.08 and 3.0.

19. The transmission assembly according to claim 5, wherein there are at least two pawls in each PTC and each PTC further comprises a coupling member for coupling its at least two pawls such that the effect of a non-symmetrical force on said at least two pawls of each PTC is cancelled.

20. The transmission assembly according to claim 5, further comprising a mechanism to produce a shifting hysteresis between up-shifting and downshifting between transmission ratios.

21. The transmission assembly according to claim 18, wherein the mechanism to produce a shifting hysteresis is a spring biased mechanism producing a friction force on at least one pawl of each PTC.

22. A planetary transmission cassette comprising a planetary gear sub-system and a ratchet mechanism, the planetary gear sub-system comprising a central sun cog, at least two pinion gears arranged around the sun cog and whose teeth mesh with those of the sun cog, and a crown gear surrounding the pinion gears and whose teeth mesh with those of the pinion gears, the sun cog orthogonally passing through the rotational axis of a planetary gear carrier to which the pinions are pivotably held; the ratchet mechanism comprising at least one pawl engageable with a groove on the planetary gear carrier.

23. A wheel comprising a wheel hub fitted with an internal mechanical automatic transmission assembly according to claim 1.

24. A mechanical apparatus comprising a power source geared to a rotational mechanical output according to claim 1.

25. A transmission assembly according to claim 1, further comprising a multiplication assembly which comprises a moment pickup member designed for rotationally engaging with a current PTC and transferring rotary motion to the hub; a multiplier engaging member is rotatably fixed to the hub and is formed with one or more radial engagement members for engaging with a multiplication planetary gear assembly, which in turn is engaged with a crown gear of said moment pickup member; whereby rotation of the moment sleeve at a speed exceeding engagement speed of the engagement members entails engagement of the multiplication planetary gear assembly to thereby reduce speed of the moment sleeve and correspondingly of the PTCs.

26. A transmission assembly according to claim 25, wherein the multiplication planetary gear assembly comprises a plurality of pinion gears each being engaged in turn with a corresponding inverting gear which in turn are each engaged with a central sun cog of a cog plate rotatably fixable with the multiplier engaging member.

27. A transmission assembly according to claim 25, wherein the moment pickup member is a sleeve rotatably fixed to the hub by a unidirectional roller bearing or ratchet mechanism formed on a periphery of the moment sleeve.

28. An inverted gear assembly comprising a transmission assembly according to claim 1, wherein an increasing input yields a decreasing output.
